(19) United States
(12) Patent Application Publication
(10) Pub. No.: US 2009/0164745 A1
(43) Pub. Date: Jun. 25, 2009

(54) System and Method for Controlling an Amount of Unprogrammed Capacity in Memory Blocks of a Mass Storage System

(76) Inventors: Alan Sinclair, Falkirk (GB); Barry Wright, Edinburgh (GB)

Correspondence Address: BRINKS HOFER GILSON & LIONE/SanDisk, P.O. BOX 10395, CHICAGO, IL, 60610, US

(21) Appl. No.: 11/963,413

(22) Filed: Dec. 21, 2007

(51) Int. Cl. G06F 12/06

(52) U.S. Cl. 711/170; 711/E12.084

(57) ABSTRACT

Systems and methods for allocating blocks at a reprogrammable non-volatile mass storage system are disclosed. Generally, a controller identifies a group of data to be written to a block at the mass storage system, and allocates one of a new block or a partial block to the identified group of data based on whether a total unprogrammed capacity in partial blocks of the mass storage system exceeds an amount of valid data in obsolete blocks of the mass storage system. In one implementation, the identifier group of data may be associated with a single file.

### CROSS-REFERENCE TO RELATED APPLICATIONS

Reference is made to the following United States patent applications pertaining to direct data file storage in flash memory systems:

1) Ser. No. 11/060,249, entitled “Direct Data File Storage in Flash Memories” (publication no. 2006-0184720 A1), No. 11/060,174, entitled “Direct File Data Programming and Deletion in Flash Memories” (publication no. 2006-0184718 A1), and Ser. No. 11/060,248, entitled “Direct Data File Storage Implementation Techniques in Flash Memories” (publication no. 2006-0184719 A1), all filed Feb. 16, 2005, and related application Ser. No. 11/342,170 (publication no. 2006-0184723 A1) and Ser. No. 11/342,168 (publication no. 2006-0184722 A1), both filed Jan. 26, 2006;

2) No. 60/705,388, filed Aug. 3, 2005, Ser. No. 11/461,997, entitled “Data Consolidation and Garbage Collection in Direct Data File Storage in Flash Memories,” Ser. No. 11/462,007, entitled “Data Operations in Flash Memories Utilizing Direct Data File Storage,” and related application Ser. Nos. 11/462,001 and 11/462,013, all filed Aug. 2, 2006.

3) Ser. No. 11/196,869, filed Aug. 3, 2005, entitled “Interfacing Systems Operating Through a Logical Address Space and on a Direct Data File Basis.”

4) Ser. No. 11/196,168, filed Aug. 3, 2005, entitled “Method and System for Dual Mode Access for Storage Devices.”

5) Ser. No. 11/250,299, entitled “Method of Storing Transformed Units of Data in a Memory System Having Fixed Sized Storage Blocks,” and related application Ser. No. 11/250,794, both filed Oct. 13, 2005.

6) Ser. No. 11/259,423, entitled “Scheduling of Reclaim Operations in Non-Volatile Memory,” and related application Ser. No. 11/259,439, both filed Oct. 25, 2005.

7) Ser. No. 11/302,764, entitled “Logically-Addressed File Storage Methods,” and related application Ser. No. 11/300,568, both filed Dec. 13, 2005.

8) Ser. No. 11/316,577, entitled “Enhanced Host Interfacing Methods,” and related application Ser. No. 11/316,578, both filed Dec. 21, 2005.

9) Ser. No. 11/314,842, filed Dec. 21, 2005, entitled “Dual Mode Access for Non-Volatile Storage Devices.”

10) Ser. No. 11/313,567, entitled “Method and System for Accessing Non-Volatile Storage Devices,” and related application Ser. No. 11/313,633, both filed Dec. 21, 2005.

11) Ser. No. 11/382,224, entitled “Management of Memory Blocks that Directly Store Data Files,” and related application Ser. No. 11/382,228, both filed May 8, 2006.

12) Ser. No. 11/382,232, entitled “Reclaiming Data Storage Capacity in Flash Memories,” and related application Ser. No. 11/382,235, both filed May 8, 2006.

13) No. 60/746,742, filed May 8, 2006, Ser. No. 11/459,255, entitled “Indexing of File Data in Reprogrammable Non-Volatile Memories that Directly Store Data Files,” and related application Ser. No. 11/459,246, both filed Jul. 21, 2006.

14) No. 60/746,740, filed May 8, 2006, No. 11/459,268, entitled “Methods of Managing Blocks in Nonvolatile Memory,” and related application Ser. No. 11/459,260, both filed Jul. 21, 2006.

15) Ser. No. 11/616,242, entitled “Use of a Direct Data File System with a Continuous Logical Address Space Interface”, and related application Ser. Nos. 11/616,236; 11/616,231; 11/616,228; 11/616,226; and 11/616,218, all filed Dec. 26, 2006.

The above applications, collectively referred to herein as the “Direct Data File Storage Applications”, and all patents, patent applications, articles and other publications, documents and things referenced subsequently herein are hereby incorporated by reference in their entirety for all purposes.

This application is also related to “System For Interfacing A Host Operating Through A Logical Address Space With A Direct File Storage Medium,” U.S. patent application Ser. No. 11/760,480, filed Jun. 8, 2007, which is hereby incorporated by reference.

This application is also related to “System For Interfacing A Host Operating Through A Logical Address Space With A Direct File Storage Medium,” U.S. patent application Ser. No. 11/760,469, filed Jun. 8, 2007, which is hereby incorporated by reference.

### TECHNICAL FIELD

This application relates generally to data communication between electronic systems having different interfaces. More specifically, this application relates to the operation of memory systems, such as re-programmable non-volatile semiconductor flash memory, and a host device to which the memory is connected or connectable.

### BACKGROUND

When writing data to a conventional flash data memory system, a host typically assigns unique logical addresses to sectors, clusters or other units of data within a continuous virtual address space of the memory system. The host writes data to, and reads data from, addresses within the logical address space of the memory system. The memory system then commonly maps data between the logical address space and the physical blocks or metablocks of the memory, where data is stored in fixed logical groups corresponding to ranges in the logical address space. Generally, each fixed logical group is stored in a separate physical block of the memory system. The memory system keeps track of how the logical address space is mapped into the physical memory but the host is unaware of this. The host keeps track of the addresses of its data files within the logical address space, but the memory system operates without knowledge of this mapping.

A drawback of memory systems that operate in a logical address space, also referred to as logical block address (LBA) format, is fragmentation. Data written by a host file system may often be fragmented in logical address space, where many fixed logical groups are only partially updated with new data. The fragmentation may occur as a result of cumulative fragmentation of free space by the host file system, and possibly even as a result of inherent fragmentation of individual files by the host file system. The fragmented logical groups will need to be rewritten in full in a different physical block. The process of rewriting the fragmented logical groups may involve copying unrelated data from the prior location of the logical group. This overhead can result in lower performance and reduced device lifetime for the memory system.

### BRIEF SUMMARY

In order to address the need for improved memory system performance and to reduce fragmentation, a method for controlling an amount of unprogrammed capacity in memory blocks of a memory system is set forth.

According to one aspect, a method for allocating blocks at a reprogrammable non-volatile mass storage system is described. The method includes identifying a group of data to be written to a block at the mass storage system. The method additionally includes allocating one of a new block or a partial block to the group of data based on whether a total unprogrammed capacity in partial blocks of the mass storage system exceeds an amount of valid data in obsolete blocks of the mass storage system.

According to another aspect, a computer-readable storage medium having processor executable instructions for allocating blocks at a reprogrammable non-volatile mass storage system is described. The instructions are configured to direct a processor to identify a group of data to be written to a block at the mass storage system. The instructions are additionally configured to direct a processor to allocate one of a new block or a partial block to the group of data based on whether a total unprogrammed capacity in partial blocks of the mass storage system exceeds an amount of valid data in obsolete blocks of the mass storage system.

According to yet another aspect, a storage device comprising a non-volatile mass storage and a system monitor are described. The non-volatile mass storage comprises a plurality of blocks of memory cells. The system monitor is operative to identify a group of data to be written to a block at the mass storage and to allocate one of a new block or a partial block to the identified group of data based on whether a total unprogrammed capacity in partial blocks of the mass storage exceeds an amount of valid data in obsolete blocks of the mass storage.

According to another aspect, a method for allocating blocks at a reprogrammable non-volatile mass storage system is described. The method includes identifying a group of data to be written to a block at the mass storage system. The method additionally includes determining the group of data has been classified as a reserved file and allocating a new block to the group of data in response to determining the group of data has been classified as a reserved file.

Other features and advantages of the invention will become apparent upon review of the following drawings, detailed description and claims.

### BRIEF DESCRIPTION OF THE DRAWINGS

FIG. 1 schematically illustrates a host and a connected non-volatile memory system as currently implemented.

FIG. 2 is a block diagram of an example flash memory system for use as the non-volatile memory of FIG. 1.

FIG. 3 is a representative circuit diagram of a memory cell array that may be used in the system of FIG. 2.

FIG. 4 illustrates an example physical memory organization of the system of FIG. 2.

FIG. 5 shows an expanded view of a portion of the physical memory of FIG. 4.

FIG. 6 shows a further expanded view of a portion of the physical memory of FIGS. 4 and 5.

FIG. 7 illustrates a logical address space interface between a host and a re-programmable memory system.

FIG. 8 illustrates in a different manner than FIG. 7 a logical address space interface between a host and a re-programmable memory system.

FIG. 9 illustrates a direct data file storage interface between a host and a re-programmable memory system.

FIG. 10 illustrates, in a different manner than FIG. 9, a direct data file storage interface between a host and a re-programmable memory system.

FIG. 11 illustrates a method for monitoring and controlling an amount of unprogrammed capacity existing in partially programmed blocks in a mass storage system.

FIG. 12 illustrates logical blocks and physical blocks for a memory system that performs storage address re-mapping operations.

FIG. 13 illustrates logical blocks and physical blocks for a memory system that performs storage address re-mapping operations that attempt to create partial blocks when possible.

FIG. 14 illustrates a method for monitoring and controlling an amount of unprogrammed capacity in partial blocks of a memory system that performs storage address re-mapping operations.

### DETAILED DESCRIPTION

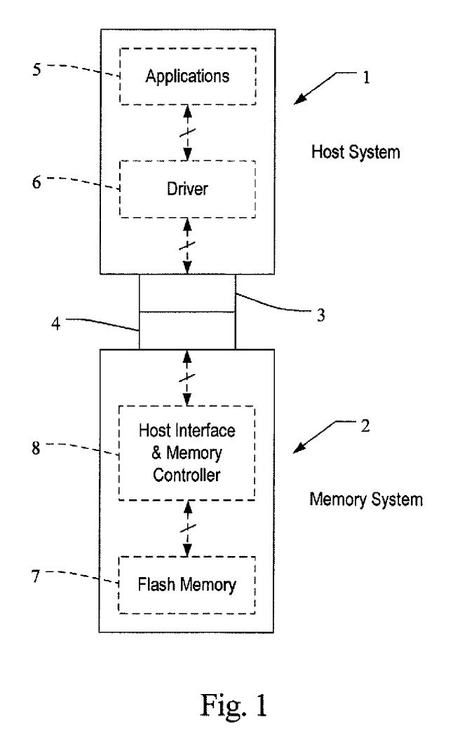

A flash memory system suitable for use in implementing aspects of the invention is shown in FIGS. 1-6. A host system 1 of FIG. 1 stores data into and retrieves data from a flash memory 2. Although the flash memory can be embedded within the host, such as in the form of a solid state disk drive installed in a personal computer, the memory 2 is illustrated to be in the form of a card that is removably connected to the host through mating parts 3 and 4 of a mechanical and electrical connector. There are currently many different flash memory cards that are commercially available, examples being the CompactFlash (CF), the MultiMediaCard (MMC), Secure Digital (SD), miniSD, Memory Stick, SmartMedia and TransFlash cards. Although each of these cards has a unique mechanical and/or electrical interface according to its standardized specifications, the flash memory system included in each is similar. These cards are all available from SanDisk Corporation, assignee of the present application. SanDisk also provides a line of flash drives under its Cruzer trademark, which are hand held memory systems in small packages that have a Universal Serial Bus (USB) plug for connecting with a host by plugging into the host's USB receptacle. Each of these memory cards and flash drives includes controllers that interface with the host and control operation of the flash memory within them.

Host systems that use such memory cards and flash drives are many and varied. They include personal computers (PCs), laptop and other portable computers, cellular telephones, personal digital assistants (PDAs), digital still cameras, digital movie cameras and portable audio players. The host typically includes a built-in receptacle for one or more types of memory cards or flash drives but some require adapters into which a memory card is plugged. The memory system usually contains its own memory controller and drivers but there are also some memory-only systems that are instead controlled by software executed by the host to which the memory is connected. In some memory systems containing the controller, especially those embedded within a host, the memory, controller and drivers are often formed on a single integrated circuit chip.

The host system 1 of FIG. 1 may be viewed as having two major parts, insofar as the memory 2 is concerned, made up of a combination of circuitry and software. They are an applications portion 5 and a driver portion 6 that interfaces with the memory 2. In a personal computer, for example, the applications portion 5 can include a processor running word processing, graphics, control or other popular application software. In a camera, cellular telephone or other host system that is primarily dedicated to performing a single set of functions, the applications portion 5 includes the software that operates the camera to take and store pictures, the cellular telephone to make and receive calls, and the like.

The memory system 2 of FIG. 1 includes flash memory 7, and circuits 8 that both interface with the host to which the card is connected for passing data back and forth and control the memory 7. The controller 8 typically converts between logical addresses of data used by the host 1 and physical addresses of the memory 7 during data programming and reading.

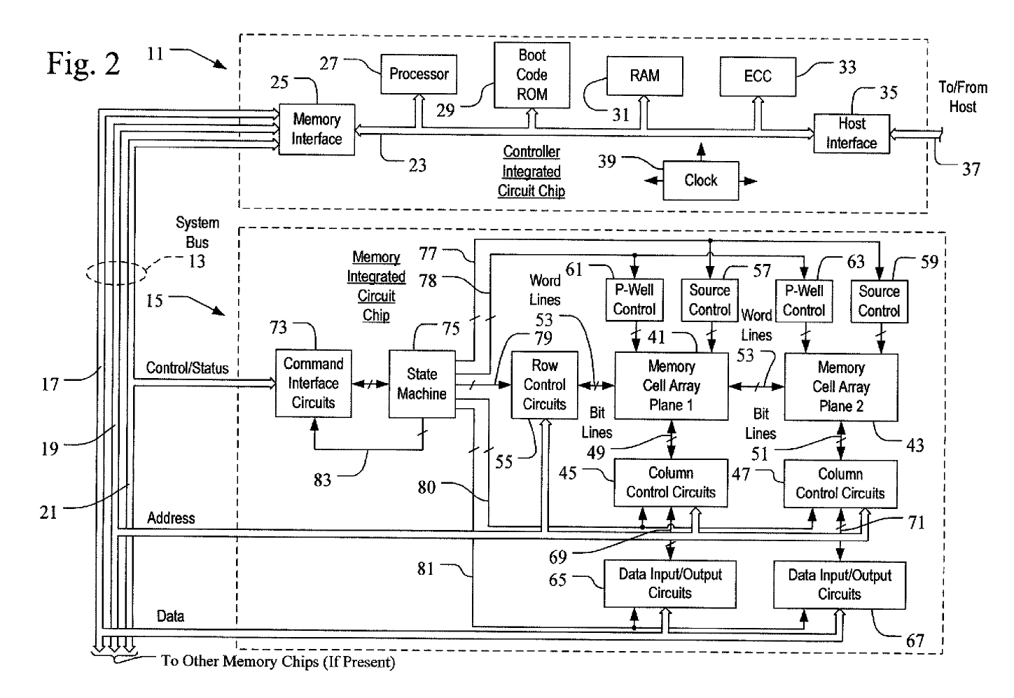

Referring to FIG. 2, circuitry of a typical flash memory system that may be used as the non-volatile memory 2 of FIG. 1 is described. The system controller is usually implemented on a single integrated circuit chip 11 that is connected in parallel with one or more integrated circuit memory chips over a system bus 13, a single such memory chip 15 being shown in FIG. 2. The particular bus 13 that is illustrated includes a separate set of conductors 17 to carry data, a set 19 for memory addresses and a set 21 for control and status signals. Alternatively, a single set of conductors may be time shared between these three functions.

A typical controller chip 11 has its own internal bus 23 that interfaces with the system bus 13 through interface circuits 25. The primary functions normally connected to the bus are a processor 27 (such as a microprocessor or micro-controller), a read-only-memory (ROM) 29 containing code to initialize (“boot”) the system, random-access-memory (RAM) 31 used primarily to buffer data being transferred between the memory and a host, and circuits 33 that calculate and check an error correction code (ECC) for data passing through the controller between the memory and the host. The controller bus 23 interfaces with a host system through circuits 35, which, in the case of the system of FIG. 2 being contained within a memory card, is done through external contacts 37 of the card that are part of the connector 4. A clock 39 is connected with and utilized by each of the other components of the controller 11.

The memory chip 15, as well as any other connected with the system bus 13, may contain an array of memory cells organized into multiple sub-arrays or planes, two such planes 41 and 43 being illustrated for simplicity but more, such as four or eight such planes, may instead be used. Alternatively, the memory cell array of the chip 15 may not be divided into planes. When so divided, however, each plane has its own column control circuits 45 and 47 that are operable independently of each other. The circuits 45 and 47 receive addresses of their respective memory cell array from the address portion 19 of the system bus 13, and decode them to address a specific one or more of respective bit lines 49 and 51. The word lines 53 are addressed through row control circuits 55 in response to addresses received on the address bus 19. Source voltage control circuits 57 and 59 are also connected with the respective planes, as are p-well voltage control circuits 61 and 63. If the memory chip 15 has a single array of memory cells, and if two or more such chips exist in the system, the array of each chip may be operated similarly to a plane or sub-array within the multi-plane chip described above.

Data are transferred into and out of the planes 41 and 43 through respective data input/output circuits 65 and 67 that are connected with the data portion 17 of the system bus 13. The circuits 65 and 67 provide for both programming data into the memory cells and for reading data from the memory cells of their respective planes, through lines 69 and 71 connected to the planes through respective column control circuits 45 and 47.

Although the controller 11 controls the operation of the memory chip 15 to program data, read data, erase and attend to various housekeeping matters, each memory chip also contains some controlling circuitry that executes commands from the controller 11 to perform such functions. Interface circuits 73 are connected to the control and status portion 21 of the system bus 13. Commands from the controller are provided to a state machine 75 that then provides specific control of other circuits in order to execute these commands. Control lines 77-81 connect the state machine 75 with these other circuits as shown in FIG. 2. Status information from the state machine 75 is communicated over lines 83 to the interface 73 for transmission to the controller 11 over the bus portion 21.

A NAND architecture of the memory cell arrays 41 and 43 is currently preferred, although other architectures, such as NOR, can also be used instead. Examples of NAND flash memories and their operation as part of a memory system may be had by reference to U.S. Pat. Nos. 5,570,315, 5,774,397, 6,046,935, 6,373,746, 6,456,528, 6,522,580, 6,771,536 and 6,781,877 and United States patent application publication no. 2003/0147278.

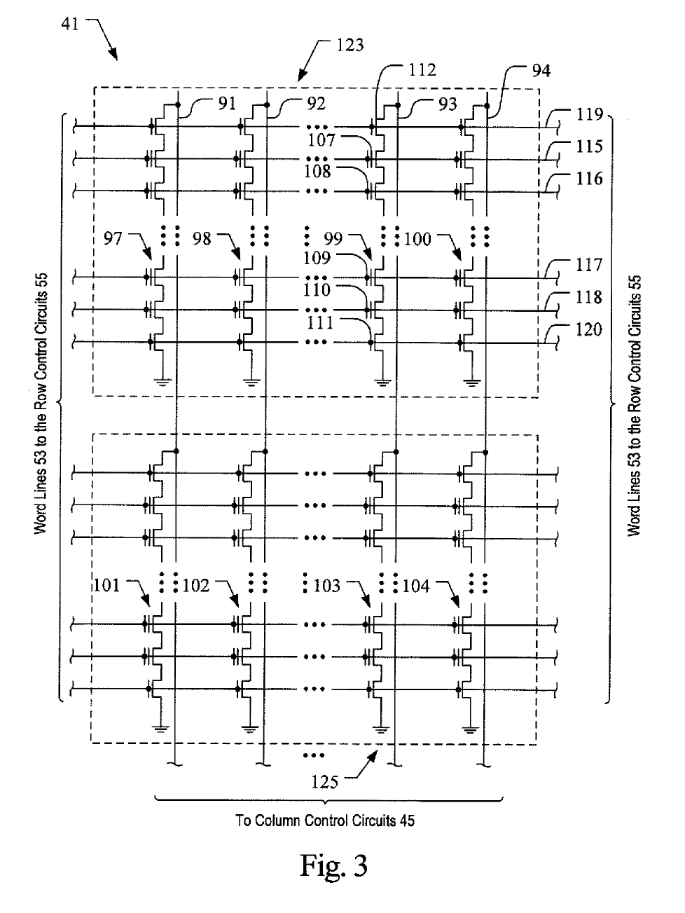

An example NAND array is illustrated by the circuit diagram of FIG. 3, which is a portion of the memory cell array 41 of the memory system of FIG. 2. A large number of global bit lines are provided, only four such lines 91-94 being shown in FIG. 2 for simplicity of explanation. A number of series connected memory cell strings 97-104 are connected between one of these bit lines and a reference potential. Using the memory cell string 99 as representative, a plurality of charge storage memory cells 107-110 are connected in series with select transistors 111 and 112 at either end of the string. When the select transistors of a string are rendered conductive, the string is connected between its bit line and the reference potential. One memory cell within that string is then programmed or read at a time.

Word lines 115-118 of FIG. 3 individually extend across the charge storage element of one memory cell in each of a number of strings of memory cells, and gates 119 and 120 control the states of the select transistors at each end of the strings. The memory cell strings that share common word and control gate lines 115-120 are made to form a block 123 of memory cells that are erased together. This block of cells contains the minimum number of cells that are physically erasable at one time. One row of memory cells, those along one of the word lines 115-118, are programmed at a time. Typically, the rows of a NAND array are programmed in a prescribed order, in this case beginning with the row along the word line 118 closest to the end of the strings connected to ground or another common potential. The row of memory cells along the word line 117 is programmed next, and so on, throughout the block 123. The row along the word line 115 is programmed last.

A second block 125 is similar, its strings of memory cells being connected to the same global bit lines as the strings in the first block 123 but having a different set of word and control gate lines. The word and control gate lines are driven to their proper operating voltages by the row control circuits 55. If there is more than one plane or sub-array in the system, such as planes 1 and 2 of FIG. 2, one memory architecture uses common word lines extending between them. There can alternatively be more than two planes or sub-arrays that share common word lines. In other memory architectures, the word lines of individual planes or sub-arrays are separately driven.

As described in several of the NAND patents and published application referenced above, the memory system may be operated to store more than two detectable levels of charge in each charge storage element or region, thereby to store more than one bit of data in each. The charge storage elements of the memory cells are most commonly conductive floating gates but may alternatively be non-conductive dielectric charge trapping material, as described in U.S. patent application publication no. 2003/0109093.

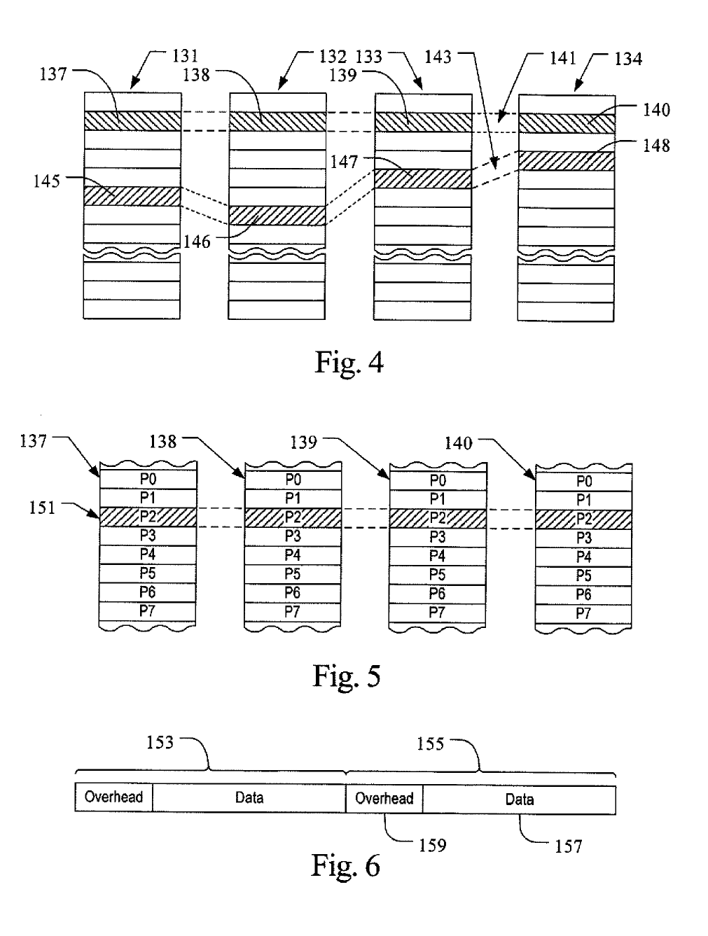

FIG. 4 conceptually illustrates an organization of the flash memory cell array 7 (FIG. 1) that is used as an example in further descriptions below. Four planes or sub-arrays 131-134 of memory cells may be on a single integrated memory cell chip, on two chips (two of the planes on each chip) or on four separate chips. The specific arrangement is not important to the discussion below. Of course, other numbers of planes, such as 1, 2, 8, 16 or more may exist in a system. The planes are individually divided into blocks of memory cells shown in FIG. 4 by rectangles, such as blocks 137, 138, 139 and 140, located in respective planes 131-134. There can be dozens or hundreds of blocks in each plane.

As mentioned above, the block of memory cells is the unit of erase, the smallest number of memory cells that are physically erasable together. For increased parallelism, however, the blocks are operated in larger metablock units. One block from each plane is logically linked together to form a metablock. The four blocks 137-140 are shown to form one metablock 141. All of the cells within a metablock are typically erased together. The blocks used to form a metablock need not be restricted to the same relative locations within their respective planes, as is shown in a second metablock 143 made up of blocks 145-148. Although it is usually preferable to extend the metablocks across all of the planes, for high system performance, the memory system can be operated with the ability to dynamically form metablocks of any or all of one, two or three blocks in different planes. This allows the size of the metablock to be more closely matched with the amount of data available for storage in one programming operation.

The individual blocks are in turn divided for operational purposes into pages of memory cells, as illustrated in FIG. 5. The memory cells of each of the blocks 137-140, for example, are each divided into eight pages P0-P7. Alternatively, there may be 16, 32 or more pages of memory cells within each block. The page is the unit of data programming and reading within a block, containing the minimum amount of data that are programmed or read at one time. In the NAND architecture of FIG. 3, a page is formed of memory cells along a word line within a block. However, in order to increase the memory system operational parallelism, such pages within two or more blocks may be logically linked into metapages. A metapage 151 is illustrated in FIG. 5, being formed of one physical page from each of the four blocks 137-140. The metapage 151, for example, includes the page P2 in of each of the four blocks but the pages of a metapage need not necessarily have the same relative position within each of the blocks. A metapage is the maximum unit of programming.

Although it is preferable to program and read the maximum amount of data in parallel across all four planes, for high system performance, the memory system can also be operated to form metapages of any or all of one, two or three pages in separate blocks in different planes. This allows the programming and reading operations to adaptively match the amount of data that may be conveniently handled in parallel and reduces the occasions when part of a metapage remains unprogrammed with data.

A metapage formed of physical pages of multiple planes, as illustrated in FIG. 5, contains memory cells along word line rows of those multiple planes. Rather than programming all of the cells in one word line row at the same time, they are more commonly alternately programmed in two or more interleaved groups, each group storing a page of data (in a single block) or a metapage of data (across multiple blocks). By programming alternate memory cells at one time, a unit of peripheral circuits including data registers and a sense amplifier need not be provided for each bit line but rather are time-shared between adjacent bit lines. This economizes on the amount of substrate space required for the peripheral circuits and allows the memory cells to be packed with an increased density along the rows. Otherwise, it is preferable to simultaneously program every cell along a row in order to maximize the parallelism available from a given memory system.

With reference to FIG. 3, the simultaneous programming of data into every other memory cell along a row is most conveniently accomplished by providing two rows of select transistors (not shown) along at least one end of the NAND strings, instead of the single row that is shown. The select transistors of one row then connect every other string within a block to their respective bit lines in response to one control signal, and the select transistors of the other row connect intervening every other string to their respective bit lines in response to another control signal. Two pages of data are therefore written into each row of memory cells.

The amount of data in each logical page is typically an integer number of one or more sectors of data, each sector containing 512 bytes of data, by convention. The sector is the minimum unit of data transferred to and from the memory system. FIG. 6 shows a logical data page of two sectors 153 and 155 of data of a page or metapage. Each sector usually contains a portion 157 of 512 bytes of user or system data being stored and another number of bytes 159 for overhead data related either to the data in the portion 157 or to the physical page or block in which it is stored. The number of bytes of overhead data is typically 16 bytes, making the total 528 bytes for each of the sectors 153 and 155. The overhead portion 159 may contain an ECC calculated from the data portion 157 during programming, its logical address, an experience count of the number of times the block has been erased and re-programmed, one or more control flags, operating voltage levels, and/or the like, plus an ECC calculated from such overhead data 159. Alternatively, the overhead data 169, or a portion of it, may be stored in different pages in other blocks. In either case, a sector denotes a unit of stored data with which an ECC is associated.

As the parallelism of memories increases, data storage capacity of the metablock increases and the size of the data page and metapage also increase as a result. The data page may then contain more than two sectors of data. With two sectors in a data page, and two data pages per metapage, there are four sectors in a metapage. Each metapage thus stores 2048 bytes of data. This is a high degree of parallelism, and can be increased even further as the number of memory cells in the rows is increased. For this reason, the width of flash memories is being extended in order to increase the amount of data in a page and a metapage.

The physically small re-programmable non-volatile memory cards and flash drives identified above are commercially available with various data storage capacities. The host manages data files generated or used by application software or firmware programs executed by the host. Word processing data files and drawing files of computer aided design (CAD) software are examples of data files generated by application software in general computer hosts such as PCs, laptop computers and the like. A digital camera generates a data file for each picture that is stored on a memory card. A cellular telephone utilizes data from files on an internal memory card, such as a telephone directory. A PDA stores and uses several different files, such as an address file, a calendar file, and the like. In any such application, the memory card may also contain software that operates the host.

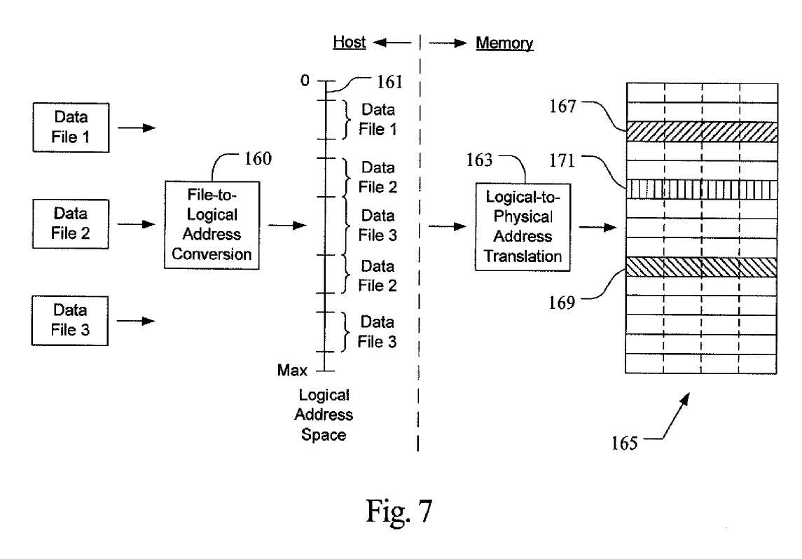

A common logical interface between the host and the memory system is illustrated in FIG. 7. A continuous logical address space 161 is large enough to provide addresses for all the data that may be stored in the memory system. The host address space is typically divided into sectors of data and is allocated by the host to files that are then incremented in clusters of data. Each cluster may be designed in a given host system to contain a number of sectors of data, somewhere between 4 and 64 sectors being typical. A standard sector contains 512 bytes of data.

Three Data Files 1, 2 and 3 are shown in the example of FIG. 7 to have been created. An application program running on the host system creates each file as an ordered set of data and identifies it by a unique name or other reference. Enough available logical address space not already allocated to other files is assigned by the host to Data File 1, by a file-to-logical address conversion 160. Data File 1 is shown to have been assigned a contiguous range of available logical addresses. Ranges of addresses are also commonly allocated for specific purposes, such as a particular range for the host operating software, which are then avoided for storing data even if these addresses have not been utilized at the time the host is assigning logical addresses to the data.

When a Data File 2 is later created by the host, the host similarly assigns two different ranges of contiguous addresses within the logical address space 161, by the file-to-logical address conversion 160 of FIG. 7. A file need not be assigned contiguous logical addresses but rather can be fragments of addresses in between address ranges already allocated to other files. This example then shows that yet another Data File 3 created by the host is allocated other portions of the host address space not previously allocated to the Data Files 1 and 2 and other data.

The host keeps track of the memory logical address space by maintaining a file allocation table (FAT), where the logical addresses assigned by the host to the various host files by the conversion 160 are maintained. The FAT table is frequently updated by the host as new files are stored, other files deleted, files modified and the like. The FAT table is typically stored in a host memory, with a copy also stored in the non-volatile memory that is updated from time to time. The copy is typically accessed in the non-volatile memory through the logical address space just like any other data file. When a host file is deleted, the host then deallocates the logical addresses previously allocated to the deleted file by updating the FAT table to show that they are now available for use with other data files.

The host is not concerned about the physical locations where the memory system controller chooses to store the files. The typical host only knows its logical address space and the logical addresses that it has allocated to its various files. The memory system, on the other hand, through the typical hosticard interface being described, only knows the portions of the logical address space to which data have been written but does not know the logical addresses allocated to specific host files, or even the number of host files. The memory system controller converts the logical addresses provided by the host for the storage or retrieval of data into unique physical addresses within the flash memory cell array where host data are stored. A block 163 represents a working table of these logical-to-physical address conversions, which is maintained by the memory system controller.

The memory system controller is programmed to store data within the blocks and metablocks of a memory array 165 in a manner to maintain the performance of the system at a high level. Four planes or sub-arrays are used in this illustration. Data are preferably programmed and read with the maximum degree of parallelism that the system allows, across an entire metablock formed of a block from each of the planes. At least one metablock 167 is usually allocated as a reserved block for storing operating firmware and data used by the memory controller. Another metablock 169, or multiple metablocks, may be allocated for storage of host operating software, the host FAT table and the like. Most of the physical storage space remains for the storage of data files. The memory controller does not know, however, how the data received has been allocated by the host among its various file objects. All the memory controller typically knows from interacting with the host is that data written by the host to specific logical addresses are stored in corresponding physical addresses as maintained by the controller's logical-to-physical address table 163.

In a typical memory system, a few extra blocks of storage capacity are provided than are necessary to store the amount of data within the address space 161. One or more of these extra blocks may be provided as redundant blocks for substitution for other blocks that may become defective during the lifetime of the memory. The logical grouping of blocks contained within individual metablocks may usually be changed for various reasons, including the substitution of a redundant block for a defective block originally assigned to the metablock. One or more additional blocks, such as metablock 171, are typically maintained in an erased block pool. Most of the remaining metablocks shown in FIG. 7 are used to store host data. When the host writes data to the memory system, the function 163 of the controller converts the logical addresses assigned by the host to physical addresses within a metablock in the erased block pool. Other metablocks not being used to store data within the logical address space 161 are then erased and designated as erased pool blocks for use during a subsequent data write operation. In a preferred form, the logical address space is divided into logical groups that each contain an amount of data equal to the storage capacity of a physical memory metablock, thus allowing a one-to-one mapping of the logical groups into the metablocks.

Data stored at specific host logical addresses are frequently overwritten by new data as the original stored data become obsolete. The memory system controller, in response, writes the new data in an erased block and then changes the logical-to-physical address table for those logical addresses to identify the new physical block to which the data at those logical addresses are stored. The blocks containing the original data at those logical addresses are then erased and made available for the storage of new data. Such erasure often must take place before a current data write operation may be completed if there is not enough storage capacity in the pre-erased blocks from the erase block pool at the start of writing. This can adversely impact the system data programming speed. The memory controller typically learns that data at a given logical address has been rendered obsolete by the host only when the host writes new data to their same logical address. Many blocks of the memory can therefore be storing such invalid data for a time.

The sizes of blocks and metablocks are increasing in order to efficiently use the area of the integrated circuit memory chip. This results in a large proportion of individual data writes storing an amount of data that is less than the storage capacity of a metablock, and in many cases even less than that of a block. Since the memory system controller normally directs new data to an erased pool metablock, this can result in portions of metablocks going unfilled. If the new data are updates of some data stored in another metablock, remaining valid metapages of data from that other metablock having logical addresses contiguous with those of the new data metapages are also desirably copied in logical address order into the new metablock. The old metablock may retain other valid data metapages. This results over time in data of certain metapages of an individual metablock being rendered obsolete and invalid, and replaced by new data with the same logical address being written to a different metablock.

In order to maintain enough physical memory space to store data over the entire logical address space 161, such data are periodically compacted or consolidated (garbage collection). It is also desirable to maintain sectors of data within the metablocks in the same order as their logical addresses as much as practical, since this makes reading data in contiguous logical addresses more efficient. So data compaction and garbage collection are typically performed with this additional goal. Some aspects of managing a memory when receiving partial block data updates and the use of metablocks are described in U.S. Pat. No. 6,763,424.

Data compaction typically involves reading all valid data metapages from a metablock and writing them to a new block, ignoring metapages with invalid data in the process. The metapages with valid data are also preferably arranged with a physical address order that matches the logical address order of the data stored in them. The number of metapages occupied in the new metablock will be less than those occupied in the old metablock since the metapages containing invalid data are not copied to the new metablock. The old block is then erased and made available to store new data. The additional metapages of capacity gained by the consolidation can then be used to store other data.

During garbage collection, metapages of valid data with contiguous or near contiguous logical addresses are gathered from two or more metablocks and re-written into another metablock, usually one in the erased block pool. When all valid data metapages are copied from the original two or more metablocks, they may be erased for future use.

Data consolidation and garbage collection take time and can affect the performance of the memory system, particularly if data consolidation or garbage collection needs to take place before a command from the host can be executed. Such operations are normally scheduled by the memory system controller to take place in the background as much as possible but the need to perform these operations can cause the controller to have to give the host a busy status signal until such an operation is completed. An example of where execution of a host command can be delayed is where there are not enough pre-erased metablocks in the erased block pool to store all the data that the host wants to write into the memory, so data consolidation or garbage collection is needed first to clear one or more metablocks of valid data, which can then be erased. Attention has therefore been directed to managing control of the memory in order to minimize such disruptions. Many such techniques are described in the following United States patent applications, referenced hereinafter as the “LBA Patent Applications”: Ser. No. 10/749,831, filed Dec. 30, 2003, entitled “Management of Non-Volatile Memory Systems Having Large Erase Blocks”; Ser. No. 10/750,155, filed Dec. 30, 2003, entitled “Non-Volatile Memory and Method with Block Management System”; Ser. No. 10/917,888, filed Aug. 13, 2004, entitled “Non-Volatile Memory and Method with Memory Planes Alignment”; Ser. No. 10/917,867, filed Aug. 13, 2004; Ser. No. 10/917,889, filed Aug. 13, 2004, entitled “Non-Volatile Memory and Method with Phased Program Failure Handling”; Ser. No. 10/917,725, filed Aug. 13, 2004, entitled “Non-Volatile Memory and Method with Control Data Management”; Ser. No. 11/192,220, filed Jul. 27, 2005, entitled “Non-Volatile Memory and Method with Multi-Stream Update Tracking”; Ser. No. 11/192,386, filed Jul. 27, 2005, entitled “Non-Volatile Memory and Method with Improved Indexing for Scratch Pad and Update Blocks”; and Ser. No. 11/191,686, filed Jul. 27, 2005, entitled “Non-Volatile Memory and Method with Multi-Stream Updating”.

One challenge to efficiently controlling operation of memory arrays with very large erase blocks is to match and align the number of data sectors being stored during a given write operation with the capacity and boundaries of blocks of memory. One approach is to configure a metablock used to store new data from the host with less than a maximum number of blocks, as necessary to store a quantity of data less than an amount that fills an entire metablock. The use of adaptive metablocks is described in U.S. patent application Ser. No. 10/749,189, filed Dec. 30, 2003, entitled “Adaptive Metablocks.” The fitting of boundaries between blocks of data and physical boundaries between metablocks is described in patent application Ser. No. 10/841,118, filed May 7, 2004, and Ser. No. 11/016,271, filed Dec. 16, 2004, entitled “Data Run Programming.”

The memory controller may also use data from the FAT table, which is stored by the host in the non-volatile memory, to more efficiently operate the memory system. One such use is to learn when data has been identified by the host to be obsolete by deallocating their logical addresses. Knowing this allows the memory controller to schedule erasure of the blocks containing such invalid data before it would normally learn of it by the host writing new data to those logical addresses. This is described in U.S. patent application Ser. No. 10/897,049, filed Jul. 21, 2004, entitled “Method and Apparatus for Maintaining Data on Non-Volatile Memory Systems.” Other techniques include monitoring host patterns of writing new data to the memory in order to deduce whether a given write operation is a single file, or, if multiple files, where the boundaries between the files lie. U.S. patent application Ser. No. 11/022,369, filed Dec. 23, 2004, entitled “FAT Analysis for Optimized Sequential Cluster Management,” describes the use of techniques of this type.

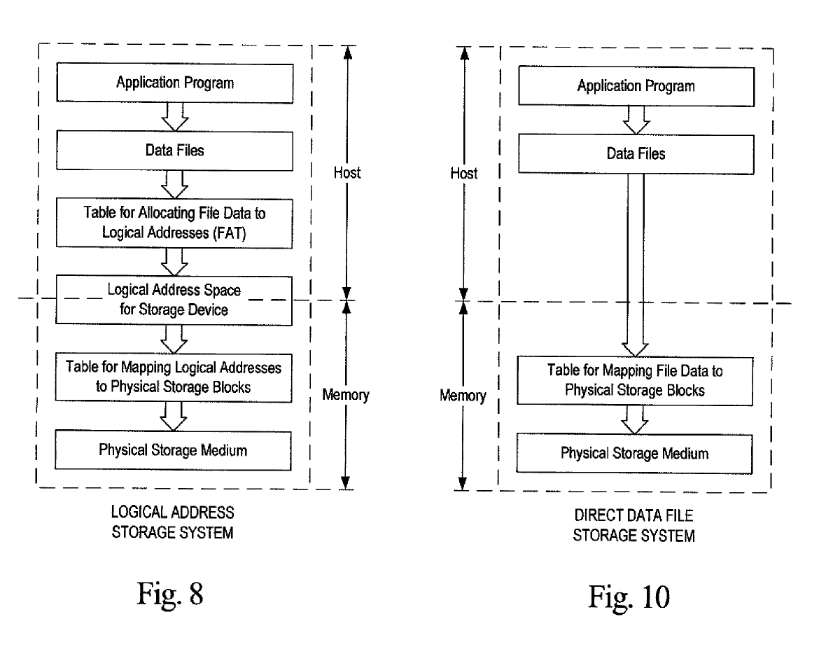

To operate the memory system efficiently, it is desirable for the controller to know as much about the logical addresses assigned by the host to data of its individual files as it can. Data files can then be stored by the controller within a single metablock or group of metablocks, rather than being scattered among a larger number of metablocks when file boundaries are not known. The result is that the number and complexity of data consolidation and garbage collection operations are reduced. The performance of the memory system improves as a result. But it is difficult for the memory controller to know much about the host data file structure when the host/memory interface includes the logical address space 161 (FIG. 7), as described above. Referring to FIG. 8, the typical logical address host/memory interface as already shown in FIG. 7 is illustrated differently. The host generated data files are allocated logical addresses by the host. The memory system then sees these logical addresses and maps them into physical addresses of blocks of memory cells where the data are actually stored.

A different type of interface between the host and memory system, termed a direct data file interface, also referred to as direct file storage (DFS), does not use the logical address space. The host instead logically addresses each file by a unique number, or other identifying reference, and offset addresses of units of data (such as bytes) within the file. This file address is given directly by the host to the memory system controller, which then keeps its own table of where the data of each host file are physically stored. This new interface can be implemented with the same memory system as described above with respect to FIGS. 2-6. The primary difference with what is described above is the manner in which that memory system communicates with a host system.

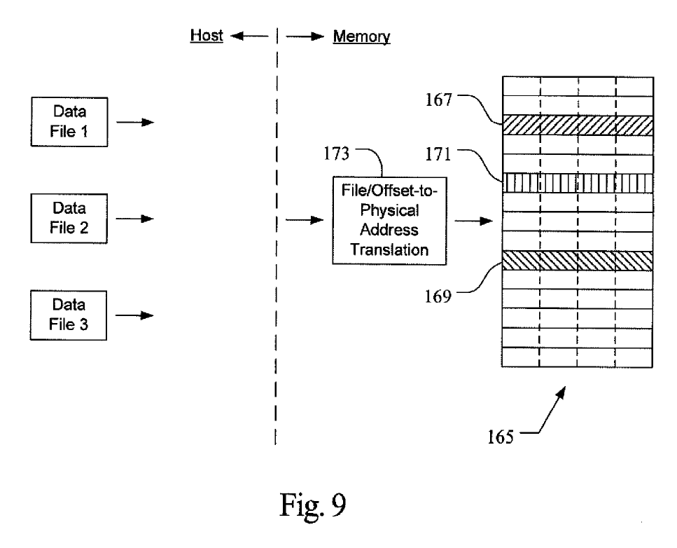

A DFS file interface is illustrated in FIG. 9, which may be compared with the logical address interface of FIG. 7. An identification of each of the Files 1, 2 and 3 and offsets of data within the files of FIG. 9 are passed directly from the host to the memory controller. This logical file address information is then translated by a memory controller function 173 into physical addresses of metablocks and metapages of the memory 165. A file directory keeps track of the host file to which each stored sector or other unit of data belongs.

The direct data file interface is also illustrated by FIG. 10, which should be compared with the logical address interface of FIG. 8. The logical address space and host maintained FAT table of FIG. 8 are not present in FIG. 10. Rather, data files generated by the host are identified to the memory system by file number and offsets of data within the file. The memory system controller then directly maps the files to the physical blocks of the memory cell array and maintains directory and index table information of the memory blocks into which host files are stored. It is then unnecessary for the host to maintain the file allocation table (FAT) that is currently necessary for managing a logical address interface.

Because the memory system knows the locations of data making up each file, these data may be erased soon after a host deletes the file. This is not possible with a typical logical address interface. Further, by identifying host data by file objects instead of using logical addresses, the memory system controller can store the data in a manner that reduces the need for frequent data consolidation and collection. The frequency of data copy operations and the amount of data copied are thus significantly reduced, thereby increasing the data programming and reading performance of the memory system.

Direct data file storage memory systems are described in the Direct Data File Storage Applications identified above. The direct data file interface of these Direct Data File Storage Applications, as illustrated by FIGS. 9 and 10, is simpler than the logical address space interface described above, as illustrated by FIGS. 7 and 8, and allows for improved memory system performance.

Direct data file storage memory systems often allow for an unrestricted number of partially programmed blocks to exist. By allowing partially programmed blocks, the direct data file storage memory system is able to quickly and efficiently delete files of the partially programmed blocks without having to relocate unrelated data. However, allowing an unrestricted number of partially programmed blocks may cause problems when a direct data file storage memory system needs utilize the unprogrammed capacity of the partially programmed blocks. Often, to utilize the unprogrammed capacity of the partially programmed blocks, the direct data file storage memory system must perform operations such as data consolidation operations, data collection operations, and data copy operations, thereby reducing the performance of the direct data file storage memory system. To implement direct data file storage memory systems in an efficient manner, the memory systems desire to avoid wasteful operations such as moving valid data from a partially programmed block to utilize an unprogrammed capacity of the block without the block including obsolete data. This can be achieved by ensuring that unprogrammed capacity existing in partial blocks at any time can be used in full for storage of valid data existing in obsolete blocks, which must be relocated for recovery of obsolete space.

In order to utilize partially programmed blocks while minimizing the need to frequently perform operations that would reduce the performance of the direct data file storage memory system, the direct data file storage memory system may monitor and control the amount of unprogrammed capacity existing in partially programmed blocks versus the amount of valid data in blocks that contain obsolete data. When the amount of unprogrammed capacity existing in partially programmed blocks exceeds an amount of valid data in blocks that contain obsolete data, the memory system may allocate a partial block to data to be written at the memory to prevent the creation of another partial block. However, when the amount of unprogrammed capacity existing in partially programmed blocks does not exceed an amount of valid data in blocks that contain obsolete data, the memory system may allocate a new block to data to be written at the mass storage system so that an additional partial block is created, thereby increasing the unprogrammed capacity existing in partially programmed blocks at the memory system. The direct data file storage memory system performs these actions to maintain as many files as possible as isolated files in blocks to minimize the need to relocate data after a file is deleted, while simultaneously reducing a need to consolidate partial blocks.

As explained in more detail below, to maintain as many files as possible as isolated files without creating a need for subsequent consolidation of partial blocks, when a mass storage system identifies a group of data to be written at the mass storage system, the mass storage system allocates one of a new block or a partial block to the identified group of data based on factors such as whether a total unprogrammed capacity in partial blocks of the mass storage system exceeds an amount of valid data in obsolete blocks of the mass storage system. For purposes of this application, a new block is defined to include a block of data that only contains unwritten erased capacity and a partial block is defined to include a block of data that currently contains a portion valid data and a portion of unwritten erased capacity. Further, for purposes of this application, a total unprogrammed capacity in partial blocks of a memory storage system is defined to include the amount of data in partial blocks of the mass storage system that is unwritten erased capacity. Moreover, for purposes of this application, an amount of valid data in obsolete blocks of a memory storage system is defined to include the amount of valid data in blocks that include both data that is currently valid and data that is currently invalid.

Typically, when the mass storage system determines that the total unprogrammed capacity in the partial blocks exceeds the amount of valid data in obsolete blocks, the mass storage system allocates a partial block to the identified group of data to prevent the mass storage system from creating an additional partial block. However, when the mass storage system determines that the total unprogrammed capacity in the partial blocks does not exceed the amount of valid data in obsolete blocks, the mass storage system allocates a new block to the identified group of data so that a new partial block is created, thereby increasing the total unprogrammed capacity in partial blocks.

In one implementation, as explained in more detail below, the type of block to be allocated for writing a specific group of data may additionally be a function of the current number of shared blocks for the group of data, that is, the number of blocks in which data for the specific group is stored together with data from other groups. This mechanism is used to control the maximum number of blocks for the group of data that can be shared with data for other groups, to limit the amount of data that has to be relocated to reclaim obsolete data space resulting from deletion of a group of data.

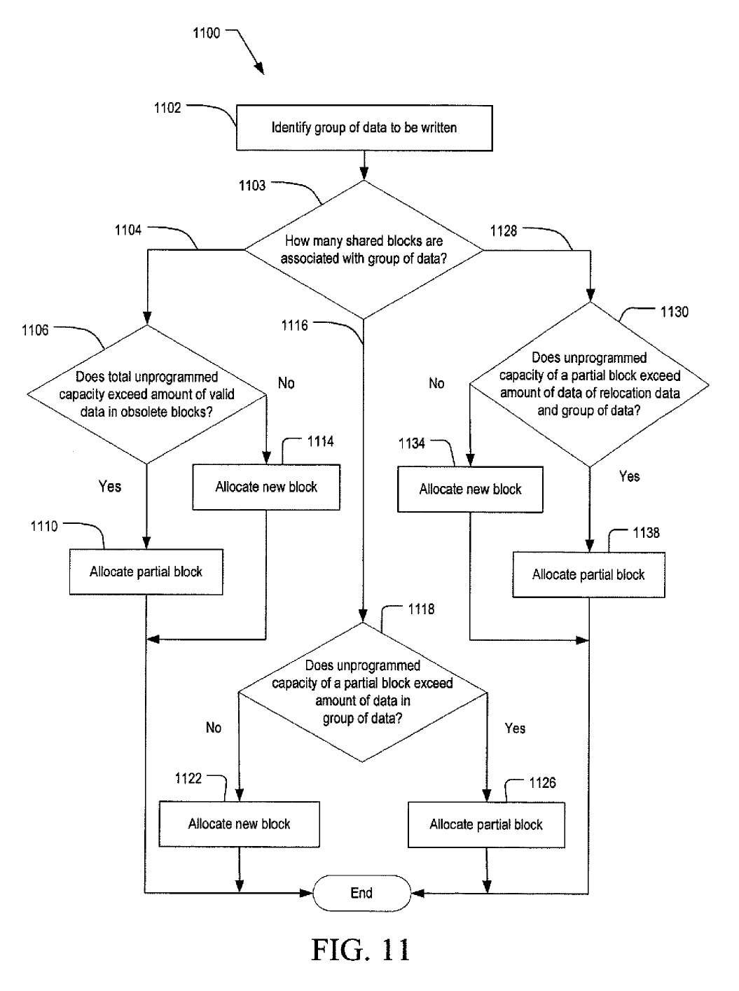

FIG. 11 illustrates a method for monitoring and controlling an amount of unprogrammed capacity existing in partially programmed blocks versus an amount of valid data in blocks that contain obsolete data. The method 1100 begins at step 1102 with a mass storage system identifying a group of data to be written at the mass storage system. The identified group of data may be data a host system sends to the mass storage system for storage at the mass storage, valid data in an obsolete block that the mass storage system identifies during a housekeeping operation, or any other type of data the mass storage system may write to blocks at the mass storage system. In one implementation the identified group of data is associated with a single file.

At step 1103, the mass storage system determines a number of shared blocks associated with the identified group of data. A block is a shared block if the block stores data for more than one group of data, such as more than one file. In one implementation, a mass storage system will permit at most two shared blocks to be associated with a group of data. However in other implementations, a mass storage system may permit more than two shard blocks to be associated with a group of data.

When the mass storage system determines at step 1103 that no shared blocks are associated with the identified group of data (branch 1104), the mass storage system determines at step 1106 whether to allocate one of a new block or a partial block to the identified group of data based on whether a total unprogrammed capacity in partial blocks of the mass storage exceeds an amount of valid data in obsolete blocks at the mass storage system.

When at step 1106, the mass storage system determines that the total unprogrammed capacity in partial blocks exceeds the amount of valid data in obsolete blocks, the mass storage system allocates a partial block to the identified group of data at step 1110.

The mass storage system allocates a partial block to the identified group of data because the mass storage system does not want to create an additional partial block. Accordingly, the identified group of data is written to an existing partial block without increasing the likelihood the mass storage system will need to perform operations such as data consolidation operations, data collection operations, and data copy operations to utilize the unprogrammed capacity of the partially programmed blocks.

Alternatively, when at step 1106, the mass storage system determines that the total unprogrammed capacity in partial blocks does not exceed the amount of valid data in obsolete blocks, the mass storage system allocates a new block to the identified group of data at step 1114.

The mass storage system allocates the new block to the identified group of data because the mass storage system is unable to move the valid data in obsolete blocks to the unprogrammed capacity in the partial blocks without the allocation of a new block of data. Therefore, the mass storage system allocates the new block to increase the total unprogrammed capacity of the partial blocks of the mass storage system, thereby reducing the likelihood the mass storage system will need to perform operations such as data consolidation operations, data collection operations, and data copy operations to utilize the unprogrammed capacity of the partially programmed blocks.

Referring again to step 1103, when the mass storage system determines that one shared block is associated with the identified group of data (branch 1116), the mass storage system determines at step 1118 whether to allocate one of a new block or a partial block to the identified group of data based on whether an unprogrammed capacity existing in an available partial block exceeds an amount of data in the identified group of data.

When at step 1118 the mass storage system determines that an unprogrammed capacity existing in an available partial block does not exceed the amount of data in the identified group of data, the mass storage system allocates a new block to the identified group of data at step 1122. The mass storage system allocates a new block to the identified group of data to avoid filling a second shared block before all the data from the identified group of data is written. Filling a second shared block would cause the mass storage system to relocate data before a remainder of the identified group of data is written.

Alternatively, when at step 1118, the mass storage system determines that an unprogrammed capacity existing in an available partial block exceeds the amount of data in the identified group of data, the mass storage system allocates a partial block to the identified group of data at step 1126. The mass storage system allocates a partial block to the identified group of data to avoid filing a second shared block before a remainder of the identifier group of data is written.

Referring again to step 1103, when the mass storage system determines that more than one shared blocks are associated with the identified group of data (branch 1128), the mass storage system determines at step 1130 whether to allocate one of a new block or a partial block to the identified group of data based on whether an unprogrammed capacity existing in an available block exceeds the sum of an amount of data that must be relocated before the group of data is written and an amount of data within the identified group of data.

When at step 1130, the mass storage system determines that an unprogrammed capacity existing in an available block does not exceed the sum of an amount of data that must be relocated before the group of data is written and an amount of data within the identified group of data, the mass storage system allocates a new block to the identified group of data at step 1134. The mass storage system allocates a new block to the identified group of data to avoid filing an additional shared block with data.

Alternatively, when at step 1130, the mass storage system determines that an unprogrammed capacity existing in an available block exceeds the sum of an amount of data that must be relocated before the group of data is written and an amount of data within the identified group of data, the mass storage system allocates a partial block to the identified group of data at step 1138. The mass storage system allocates a partial block to the identified group of data to avoid filling an additional shared block with data.

While the method described above with respect to FIG. 11 describes a mass storage system allocating one of a new block or a partial block to a group of data, in some implementations, the mass storage system may utilize groups of data, known as reserved files, which must always be allocated a new block. The mass storage system maintains reserved files indefinitely in blocks that are not shared with other files so that the mass storage system may quickly and efficiently delete the reserved files without having to relocate unrelated data.

Additionally, while the method described above with respect FIG. 11 has been described with respect to a direct file system, similar methods could be employed in memory systems using LBA interfaces that perform storage address re-mapping operations. One example of memory systems using LBA interfaces that perform storage address re-mapping operations is disclosed in U.S. Provisional Pat. App. No. 60/942,900, filed Jun. 8, 2007, the entirety of which is hereby incorporated by reference.

Typically, memory storage systems using LBA interfaces that perform storage address re-mapping operations do not perform flush operations to move valid data from an obsolete block until a minimum amount of valid data remains in the obsolete block. The memory storage system utilizes one write block to sequentially store data received from a host application and utilizes one relocation block to sequentially store valid data relocated from obsolete blocks. The memory storage system generally does not open an additional write block or relocation block until a current write block or relocation block are completely full.

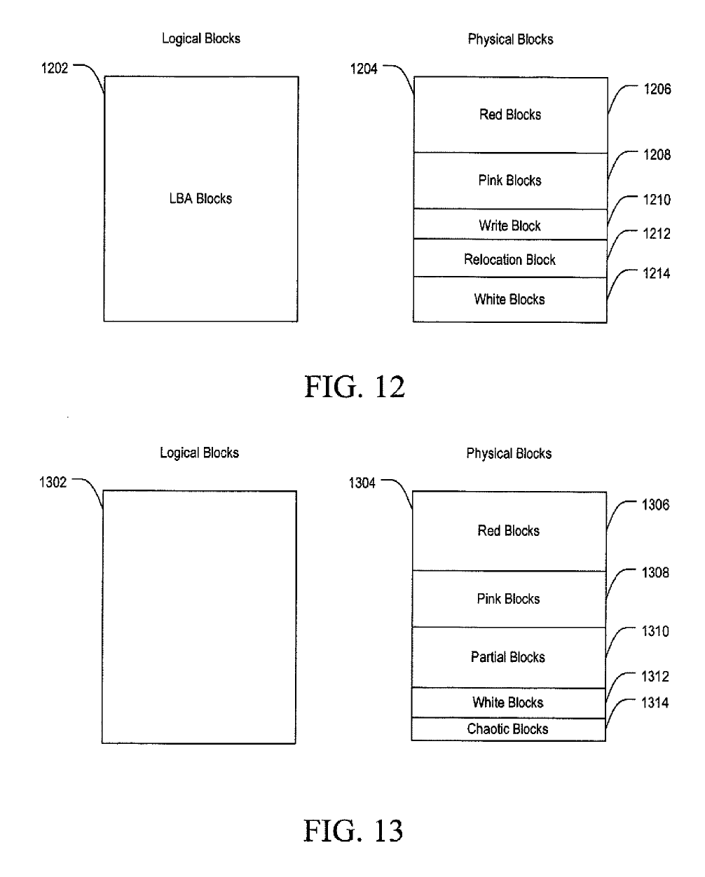

FIG. 12 illustrates logical blocks 1202 and physical blocks 1204 in one version of a memory system that performs storage address re-mapping operations such as the memory systems disclosed in U.S. Provisional Pat. App. No. 60/942,900. The physical blocks 1204 includes blocks that are fully written and are filled with valid data, also known as red blocks 1206; blocks that have been fully written and contain a combination of valid data and data that has been made obsolete as a result of a file being deleted or being updated, also known as pink blocks 1208; a block that the memory storage system writes data received from a host system to, also known as a write block 1210; a block that the memory storage system stores valid data from obsolete blocks to, also known as a relocation block 1212; and blocks that either contain no valid data or are erased, also known as white blocks 1214.

To reduce fragmentation of LBA blocks, a memory system that performs storage address re-mapping operations may use a method similar to that described above with respect to FIG. 11 to create partial blocks when possible, where each partial block contains valid data restricted to a single LBA block. By creating partial blocks when possible, the memory system may flush a block without a need to relocate valid data in the subsequent event of sequential data being made obsolete within its LBA block. However, the memory system controls a number of partial blocks to avoid any need to consolidate data from two or more partial blocks into one block.

The memory system attempts to only create a new partial block when there is sufficient valid data in all blocks containing obsolete data to fill the unprogrammed capacity in partial blocks of the memory system during flush operations. By only creating a new partial block when the amount of valid data in obsolete blocks exceeds the unprogrammed capacity of current partial blocks, the memory system ensures that data from two partial blocks will not be consolidated into one block.

FIG. 13 illustrates logical blocks 1302 and physical blocks 1304 for a memory system that performs storage address re-mapping operations that attempts to control an amount of unprogrammed capacity in partial blocks. The physical blocks 1304 includes red blocks 1306; pink blocks 1308; blocks that have been partially written and contain a combination of valid data and unwritten erased capacity, also known as partial blocks 1310; white blocks 1312; and blocks that have been partially written with data for a specific range of LBA addresses, also known as chaotic blocks 1314. Partial blocks 1310 and chaotic blocks 1314 may additionally include obsolete data resulting from either previously written data in a block being updated, or from a file being deleted by a host.

When the physical blocks 1204, 1304 illustrated in FIGS. 12 and 13 are compared, it will be appreciated that unlike the physical blocks 1204 of the general memory systems illustrated in FIG. 12, memory systems that perform storage address re-mapping operations that attempts to control an amount of unprogrammed capacity in partial blocks utilize partial blocks 1310 and chaotic blocks 1314 as illustrated in FIG. 13.

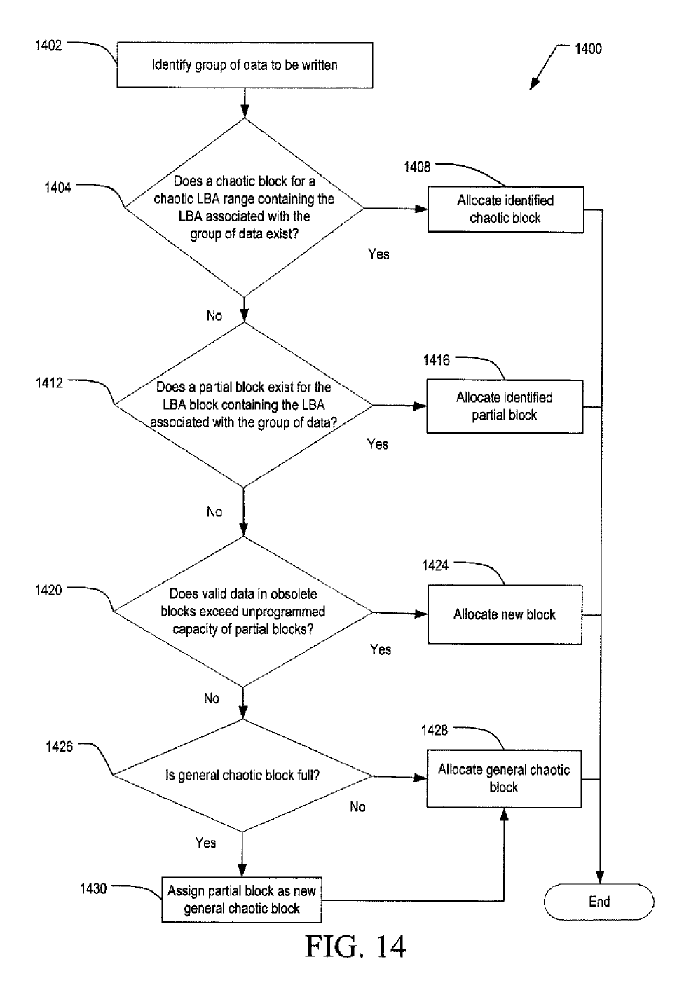

FIG. 14 illustrates a method for monitoring and controlling an amount of unprogrammed capacity in partial blocks of a memory system that performs storage address re-mapping operations. The method 1400 begins at step 1402 with the memory system identifying a group of data to be written at the mass storage system. The identified group of data may be data a host application sends to the memory system for storage at the memory system, or data that the memory system relocates during operations such as a block flush operation.

At step 1404, the memory system determines whether a chaotic block exists for a chaotic LBA range containing a LBA associated with the identified group of data. For purposes of this application, a chaotic block is defined to include a block that has been partially written with data for a specific range of LBA addresses. The range of LBA addresses may span multiple blocks, and need not comprise an integral number of LBA blocks. The block may contain obsolete data resulting from previously written data in the block being updated, or obsolete data resulting from data being deleted by a host application. In one implementation, chaotic LBA ranges may be defined according to specific write patterns by a host for data within a block.

When the memory system determines that a chaotic block exists for the chaotic LBA range containing the LBA associated with the identified group of data, the memory system allocates the identified chaotic block to the identified group of data at step 1408. The memory system allocates the identified chaotic block to the identified group of data so that data of the associated LBA range is stored in the same chaotic block. This may be done for an LBA range that relates to frequently updated information, such as host metadata. Examples of such host metadata are root directory and file allocation data for the FAT file system, and $mft and $bitmap file data in the NTFS file system.

However, when the memory system does not identify a chaotic block for the chaotic LBA range containing the LBA associated with the identified group of data, the method proceeds to step 1412 where the memory system determines whether an existing partial block exists for the LBA block containing the LBA associated with the identified group of data.

When the memory system determines that an existing partial block exists for the LBA block containing the LBA associated with the identified group of data, the memory system allocates the identified existing partial block to the identified group of data at step 1416. The memory system allocates the existing partial block to the identified group of data so that the data of the associated LBA range is stored in the same existing partial block.

However, when the memory system does not identify an existing partial block for the LBA block containing the LBA associated with the identified group of data, the method proceeds to step 1420 where the memory system determines whether to allocate a new block to the identified group of data based on whether the valid data in obsolete blocks of the memory system exceeds the unprogrammed capacity of partial blocks of the memory system.

When the memory system determines that the valid data in obsolete blocks of the memory system exceeds the unprogrammed capacity of partial blocks of the memory system, the memory system allocates a new block to the identified group of data at step 1424. In one implementation, the new block will contain data for a single LBA block. By creating a new block, the memory system reduces the possibility that data from two partial blocks will be consolidated into one block

Alternatively, when the memory system determines the valid data in obsolete blocks of the memory system does not exceed the unprogrammed capacity of partial blocks of the memory system, the method proceeds to step 1426 wherein the memory system determines whether a general chaotic block is full. When the general chaotic block is not full, the memory system allocates the general chaotic block to the identified group of data at step 1428. However, when the general chaotic block is full, the memory system assigns an existing partial block as a new general chaotic block at step 1430. In one implementation, at step 1430, the memory system assigns an existing partial block with the lowest partial capacity as the new general chaotic block. After assigning an existing partial block as a new general chaotic block, the method proceeds to step 1428 where the general chaotic block is allocated to the identified group of data.

FIGS. 1-14 teach systems and methods for controlling an amount of unprogrammed capacity in partial blocks of a mass storage system. Similar methods to control the amount of unprogrammed capacity in partial blocks may be implemented in mass storage systems implementing direct file storage systems and mass storage systems using LBA interfaces that perform storage address re-mapping operations. In each system and method, the mass storage system determines whether to allocate a new block or a partial block to an identified group of data to be written at the mass storage system based on whether valid data in obsolete blocks at the mass storage system exceeds a total unprogrammed capacity of partial blocks at the mass storage system.

It is therefore intended that the foregoing detailed description be regarded as illustrative rather than limiting, and that it be understood that it is the following claims, including all equivalents, that are intended to define the spirit and scope of this invention.

1. A method for allocating blocks at a reprogrammable non-volatile mass storage system, the method comprising:
identifying a group of data to be written to a block at the mass storage system; and
allocating one of a new block or a partial block to the identified group of data based on whether a total unprogrammed capacity in partial blocks of the mass storage system exceeds an amount of valid data in obsolete blocks of the mass storage system.

2. The method of claim 1, wherein the new block is allocated to the identified group of data when the total unprogrammed capacity in the partial blocks does not exceed the amount of valid data in obsolete blocks of the mass storage system.

3. The method of claim 1, wherein the partial block is allocated to the identified group of data when the total unprogrammed capacity in the partial blocks exceeds the amount of valid data in obsolete blocks of the mass storage system.

4. The method of claim 1, further comprising:
determining a number of shared blocks associated with the identified group of data; and
wherein the allocation of one of the new block or the partial block to the identified group of data based on whether the total unprogrammed capacity in partial blocks of the mass storage system exceeds the amount of valid data in obsolete blocks of the mass storage system is performed upon a determination that there are no shared blocks associated with the identified group of data.

5. The method of claim 4, further comprising:
allocating one of a new block or a partial block to the identified group of data based on whether an unprogrammed capacity in an available partial block exceeds an amount of data in the identified group of data upon a determination that there is one shared block associated with the identified group of data.

6. The method of claim 5, wherein the new block is allocated to the identified group of data when there is one shared block associated with the identified group of data and an unprogrammed capacity in an available partial block does not exceed an amount of data in the identified group of data.

7. The method of claim 5, wherein the partial block is allocated to the identified group of data when there is one shared block associated with the identified group of data and an unprogrammed capacity in an available partial block exceeds an amount of data in the identified group of data.

8. The method of claim 4, further comprising:
allocating one of a new block or a partial block to the identified group of data based on whether an unprogrammed capacity in an available partial block exceeds a sum of an amount of data that must be relocated before the identified group of data is written and an amount of data in the identified group of data upon a determination that more than one shared block is associated with the group of data.

9. The method of claim 8, wherein the new block is allocated to the identified group of data when there is more than one block associated with the identified group of data and an unprogrammed capacity in an available partial block does not exceed a sum of an amount of data that must be relocated before the identified group of data is written and an amount of data in the identified group of data.

10. The method of claim 8, wherein the partial block is allocated to the identified group of data when there is more than one block associated with the identified group of data and an unprogrammed capacity in an available partial block does exceeds a sum of an amount of data that must be relocated before the identified group of data is written and an amount of data in the identified group of data.

11. A computer-readable storage medium having processor executable instructions for allocating blocks at a reprogrammable non-volatile mass storage system, the instructions configured to direct a processor to perform acts of:
identifying a group of data to be written to a block at the mass storage system; and
allocating one of a new block or a partial block to the identified group of data based on whether a total unprogrammed capacity in partial blocks of the mass storage system exceeds an amount of valid data in obsolete blocks of the mass storage system.

12. The computer-readable storage medium of claim 11, wherein the new block is allocated to the identified group of data when the total unprogrammed capacity in the partial blocks does not exceed the amount of valid data in obsolete blocks of the mass storage system.

13. The computer-readable storage medium of claim 11, wherein the partial block is allocated to the identified group of data when the total unprogrammed capacity in the partial blocks exceeds the amount of valid data in obsolete blocks of the mass storage system.

14. The computer-readable storage medium of claim 11, further comprising instructions configured to direct a processor to perform acts of:
determining a number of shared blocks associated with the identified group of data; and
wherein the allocation of one of the new block or the partial block to the identified group of data based on whether the total unprogrammed capacity in partial blocks of the mass storage system exceeds the amount of valid data in obsolete blocks of the mass storage system is performed upon a determination that there are no shared blocks associated with the identified group of data.

15. The computer-readable storage medium of claim 14, further comprising instructions configured to direct a processor to perform acts of:
allocating one of a new block or a partial block to the identified group of data based on whether an unprogrammed capacity in an available partial block exceeds an amount of data in the identified group of data upon a determination that there is one shared block associated with the identified group of data.

16. The computer-readable storage medium of claim 15, wherein the new block is allocated to the identified group of data when there is one shared block associated with the identified group of data and an unprogrammed capacity in an available partial block does not exceed an amount of data in the identified group of data.

17. The computer-readable storage medium of claim 15, wherein the partial block is allocated to the identified group of data when there is one shared block associated with the identified group of data and an unprogrammed capacity in the partial block exceeds an amount of data in the identified group of data.

18. The computer-readable storage medium of claim 14, further comprising instructions configured to direct a processor to perform acts of:
allocating one of a new block or a partial block to the identified group of data based on whether an unprogrammed capacity existing in an available partial block exceeds a sum of an amount of data that must be relocated before the identified group of data is written and an amount of data in the identified group of data upon a determination that more than one shared block is associated with the group of data.

19. The computer-readable storage medium of claim 18, wherein the new block is allocated to the identified group of data when there is more than one block associated with the identified group of data and an unprogrammed capacity existing in an available partial block does not exceed a sum of an amount of data that must be relocated before the identified group of data is written and an amount of data in the identified group of data.

20. The computer-readable storage medium of claim 18, wherein the partial block is allocated to the identified group of data when there is more than one block associated with the identified group of data and an unprogrammed capacity existing in the partial block exceeds a sum of an amount of data that must be relocated before the identified group of data is written and an amount of data in the identified group of data.

21. A storage device comprising:
a non-volatile mass storage comprising a plurality of blocks of memory cells; and
a system monitor operative to:
identify a group of data to be written to a block at the mass storage; and
allocate one of a new block or a partial block to the identified group of data based on whether a total unprogrammed capacity in partial blocks of the mass storage exceeds an amount of valid data in obsolete blocks of the mass storage.

22. The storage device of claim 21, wherein the new block is allocated to the identified group of data when the total unprogrammed capacity in the partial blocks does not exceed the amount of valid data in obsolete blocks of the mass storage.

23. The storage device of claim 21, wherein the partial block is allocated to the identified group of data when the total unprogrammed capacity in the partial blocks exceeds the amount of valid data in obsolete blocks of the mass storage.

24. The storage device of claim 21, wherein the system monitor is further operative to:
determine a number of shared blocks associated with the identified group of data;
wherein the allocation of one of the new block or the partial block to the identified group of data based on whether the total unprogrammed capacity in partial blocks of the mass storage exceeds the amount of valid data in obsolete blocks of the mass storage is performed upon a determination that there are no shared blocks associated with the identified group of data.

25. The storage device of claim 24, wherein the system monitor is further operative to:
allocate one of a new block or a partial block to the identified group of data based on whether an unprogrammed capacity existing in an available partial block exceeds an amount of data in the identified group of data upon a determination that there is one shared block associated with the identified group of data.

26. The storage device of claim 25, wherein the new block is allocated to the identified group of data when there is one shared block associated with the identified group of data and an unprogrammed capacity existing in an available partial block does not exceed an amount of data in the identified group of data.

27. The storage device of claim 25, wherein the partial block is allocated to the identified group of data when there is one shared block associated with the identified group of data and an unprogrammed capacity existing in the partial block exceeds an amount of data in the identified group of data.

28. The storage device of claim 24, wherein the system monitor is further operative to:
allocate one of a new block or a partial block to the identified group of data based on whether an unprogrammed capacity existing in an available partial block exceeds a sum of an amount of data that must be relocated before the identified group of data is written and an amount of data in the identified group of data upon a determination that more than one shared block is associated with the identified group of data.

29. The storage device of claim 28, wherein the new block is allocated to the identified group of data when there is more than one block associated with the identified group of data and an unprogrammed capacity existing in an available partial block does not exceed a sum of an amount of data that must be relocated before the identified group of data is written and an amount of data in the identified group of data.

30. The storage device of claim 28, wherein the partial block is allocated to the identified group of data when there is more than one block associated with the identified group of data and an unprogrammed capacity existing in the partial block exceeds a sum of an amount of data that must be relocated before the identified group of data is written and an amount of data in the identified group of data.

31. A method for allocating blocks at a reprogrammable non-volatile mass storage system, the method comprising:
identifying a group of data to be written to a block at the mass storage system;
determining the group of data has been classified as a reserved file; and
allocating a new block to the group of data in response to determining the group of data has been classified as a reserved file.
